(19) United States
(12) Patent Application Publication
(10) Pub. No.: US 2003/0228460 A1
(43) Pub. Date: Dec. 11, 2003

(54) Fire resistant structural material and fabrics made therefrom

(76) Inventor: Younger Ahluwalia, Desoto, TX (US)

Correspondence Address: BAKER & BOTTS, 30 ROCKEFELLER PLAZA, NEW YORK, NY, 10112

(21) Appl. No.: 10/354,220

(22) Filed: Jan. 29, 2003

Related U.S. Application Data
(63) Continuation-in-part of application No. 09/663,255, filed on Sep. 15, 2000, now Pat. No. 6,586,353.
(63) Continuation-in-part of application No. 09/955,395, filed on Sep. 18, 2001.
(60) Provisional application No. 60/168,057, filed on Nov. 30, 1999.
(60) Provisional application No. 60/352,691, filed on Jan. 29, 2002.
(60) Provisional application No. 60/352,692, filed on Jan. 29, 2002.
(60) Provisional application No. 60/352,693, filed on Jan. 29, 2002.

(51) Int. Cl. B32B 5/02; B32B 27/04; B32B 27/12; B32B 3/00; B32B 3/26

(52) U.S. Cl. 428/315.5; 442/64; 442/65; 442/79; 442/97; 442/123; 442/136

(57) ABSTRACT

The present invention relates to a fire resistant structural material comprising a prefabricated microcells component, a surfactant-generated microcell component, a surfactant component, a filler component and a binder component. In addition, the present invention relates to fire resistant fabric materials comprising a substrate covered with the fire resistant structural material. Further, the present invention relates to fire resistant articles of manufacture comprising the fire resistant fabric material, and particularly to mattresses comprising the fire resistant fabric material. In its simplest embodiment, the structural material of the present invention consists essentially of a prefabricated microcells component, a filler component and a binder component.

### CROSS REFERENCE TO RELATED APPLICATIONS

This application is a continuation-in-part of pending U.S. application Ser. No. 09/663,255 filed on Sep. 15, 2000, which claims priority under 35 U.S.C. §119(e) to Provisional Application No. 60/168,057, filed Nov. 30, 1999; and this application is also a continuation-in-part of pending U.S. application Ser. No. 09/955,395 filed on Sep. 18, 2001; and this application also claims priority under 35 U.S.C. §119(e) to Provisional Application Nos. 60/352,691, 60/352,692, and 60/352,693, which were all filed on Jan. 29, 2002.

### FIELD OF THE INVENTION

This invention relates to fire resistant structural materials and to fire resistant fabric materials made therefrom and more particularly to such materials which may be adhered to decorative fabrics to provide fire resistant decorative fabrics especially suitable for use in mattresses, draperies, furniture upholstery, and the like. The invention further relates to articles of manufacture, e.g. mattresses, comprising the fire resistant fabric materials.

### BACKGROUND OF THE INVENTION

Various attempts have been made to produce fire resistant fabrics having characteristics that made them suitable for use in mattresses and in other applications, e.g., draperies and upholstery.

U.S. Pat. No. 5,540,980 is directed to a fire resistant fabric useful for mattress ticking. The fabric is formed from a corespun yarn comprising a high temperature resistant continuous filament fiberglass core and a low temperature resistant staple fiber sheath which surrounds the core. The fiberglass core comprises about 20% to 40% of the total weight of the corespun yarn while the sheath comprises about 80% to about 60% of the total weight of the corespun yarn. The corespun yam can be woven or knit to form fabric with fire resistant characteristics. When exposed to a flame, the sheath chars and the fiberglass core serves as a fire barrier. In a preferred embodiment, the sheath is made from cotton.

U.S. Pat. No. 5,091,243 discloses a fire barrier fabric comprising a substrate formed of corespun yarns and a coating carried by one surface of the substrate. Other fire resistant fabrics include Fenix™ (Milliken, LaGrange, GA) and fabrics made by Freudenberg (Lowell, Mass.), Ventex Inc. (Great Falls, Va.), BASF, Basofil Fiber Division (Enka, N.C.), Carpenter Co. (Richmond, Va.), Legget and Platt (Nashville, Tenn.), Chiquala Industries Products Group (Kingspoint, Tenn.), and Sandel (Amsterdam, N.Y.). DuPont also manufacturers a fabric made from Kevlar™ thread. In addition, the mattress industry has attempted to manufacture mattresses by using Kevlar™ thread, glass thread, flame retardant polyurethane foams, flame retardant ticking, flame retardant cotton cushioning and flame retardant tape. However, use of these materials may add to the cost of mattresses and may result in a cost-prohibitive product. Additionally, some fire-resistant threads, such as glass threads, are difficult to work with and can break, adding to the time required for manufacturing the mattress, which also translates into added costs.

Flame retardant tapes are also difficult to work with and increase production time. In addition, flame retardant tapes are only available in a limited number of colors and sizes. Flame retardant polyurethanes may release noxious gases when they smolder and ignite. Furthermore, the process for flame retarding ticking often compromises the desired characteristics of the ticking (e.g. it may no longer be soft, drapable, pliable, flexible, etc).

For many years substrates such as fiberglass have been coated with various compositions to produce materials having utility in, among other applications, the building industry. U.S. Pat. No. 5,001,005 relates to structural laminates made with facing sheets. The laminates described in that patent include thermosetting plastic foam and have planar facing sheets comprising 60% to 90% by weight glass fibers (exclusive of glass micro-fibers), 10% to 40% by weight non-glass filler material and 1% to 30% by weight non-asphaltic binder material. The filler materials are indicated as being clay, mica, talc, limestone (calcium carbonate), gypsum (calcium sulfate), aluminum trihydrate (ATH), antimony trioxide, cellulose fibers, plastic polymer fibers or a combination of any two or more of those substances. The patent further notes that the filler materials are bonded to the glass fibers using binders such as urea-, phenol- or melamine-formaldehyde resins (UF, PF, and MF resins), or a modified acrylic or polyester resin. Ordinary polymer latexes used according to the disclosure are Styrene-Butadiene-Rubber (SBR), Ethylene-Vinyl-Chloride (EVCI), PolyVinylidene Chloride (PvdC), modified PolyVinyl Chloride (PVC), PolyVinyl Alcohol (PVOH), and PolyVinyl Acetate (PVA). The glass fibers, non-glass filler material and non-asphaltic binder are all mixed together to form the facer sheets.

U.S. Pat. No. 4,745,032 discloses an acrylic coating comprised of one acrylic underlying resin which includes fly ash and an overlying acrylic resin which differs from the underlying resin.

U.S. Pat. No. 4,229,329 discloses a fire retardant coating composition comprising fly ash and vinyl acrylic polymer emulsion. The fly ash is 24 to 50% of the composition. The composition may also preferably contain one or more of a dispersant, a defoamer, a plasticizer, a thickener, a drying agent, a preservative, a fungicide and an ingredient to control the pH of the composition and thereby inhibit corrosion of any metal surface to which the composition is applied.

U.S. Pat. No. 4,784,897 discloses a cover layer material on a basis of a matting or fabric which is especially for the production of gypsum boards and polyurethane hard foam boards. The cover layer material has a coating on one side which comprises 70% to 94% powdered inorganic material, such as calcium carbonate, and 6% to 30% binder. In addition, thickening agents and cross-linking agents are added and a high density matting is used.

U.S. Pat. No. 4,495,238 discloses a fire resistant thermal insulating composite structure comprised of a mixture of from about 50% to 94% by weight of inorganic microfibers, particularly glass, and about 50% to 6% by weight of heat resistant binding agent.

U.S. Pat. No. 5,965,257, issued to the present assignee, the entire disclosure of which is incorporated herein by reference, discloses a structural article having a coating which includes only two major constituents, while eliminating the need for viscosity modifiers, for stabilizers or for blowing. The structural article of U.S. Pat. No. 5,965,257 is made by coating a substrate having an ionic charge with a coating having essentially the same iconic charge. The coating consists essentially of a filler material and a binder material. The assignee, Elk Corporation of Dallas, produces a product in accordance with the invention of U.S. Pat. No. 5,965,257 which is marketed as VersaShield®.

As indicated in U.S. Pat. No. 5,965,257, VersaShield® has many uses. However, it has been found that the products made in accordance with U.S. Pat. No. 5,965,257 are not satisfactory for certain uses because they lack sufficient drapability.

U.S. patent application Ser. No. 09/955,395, filed Sep. 18, 2001, also assigned to the present assignee, the entire disclosure of which is incorporated herein by reference addresses these inadequacies with a fire resistant fabric material comprising a substrate having an ionic charge coated with a coating having essentially the same ionic charge wherein the coating comprises a filler component which includes clay and a binder component. The fire resistant fabric material thus produced has satisfactory flexibility, pliability and drapability characteristics. However, while this material is suitable as a fire resistant fabric material, it is desirable to provide a fire resistant material that would also have cushioning or “bounceback” characteristics.

### SUMMARY OF THE INVENTION

The present invention relates to a structural material comprising a prefabricated microcell component, a surfactant component, surfactant-generated microcells, a filler component and a binder component. The structural materials are fire resistant and are useful, inter alia, for making fire resistant fabric materials which comprise a substrate coated with the structural materials of the present invention. The substrate may be planar and may have one or both sides of the substrate coated with the structural materials. Moreover, the fabric materials may further include a water repellent material, an antifungal material, an antibacterial material, a surface friction agent, a flame retardant material and/or an algaecide. Further, the fabric materials may be colored with dye. In its simplest embodiment, the structural material of the present invention consists essentially of a prefabricated microcells component, a filler component and a binder component.

The present invention also relates to a mattress fabric comprising a decorative fabric and a fabric material comprising a substrate coated with the structural materials of the present invention. Also, the present invention relates to a mattress comprising a decorative fabric and a fabric material comprising a substrate coated with the structural materials of the present invention.

In a particularly preferred embodiment, the coating does not bleed through the substrate during the material making process. The substrate may be any suitable reinforcement material capable of withstanding processing temperatures and is preferably woven fiberglass. The binder component is preferably acrylic latex and the filler preferably comprises clay. The prefabricated microcell component is preferably a hollow sphere or a component capable of forming a hollow sphere that has been constructed or manufactured before being employed in the present invention. In a preferred embodiment, the prefabricated microcell component is ceramic microspheres.

Application Ser. No. 09/955,395, filed on Sep. 18, 2001 discloses a fire resistant fabric material comprised of a coated substrate wherein the coating and the substrate have essentially the same ionic charge. The coating is comprised of a filler, including clay, and a binder. The coating does not bleed through the substrate because the ionic charges of the coating and the substrate, which are essentially the same, repel each other. In at least one embodiment, the filler component of the coating may include ceramic microspheres in addition to clay and perhaps other filler constituents. Although ceramic microspheres bear no charge, the resulting coating has essentially the same ionic charge as the substrate due to the charges associated with the clay, the binder and perhaps the other filler constituents.

The present invention also features clay and ceramic microspheres as filler constituents, but the coatings of the present invention differ from those described in application Ser. No. 09/955,395. In the present invention, the relative amount of ceramic microspheres included in the filler component of the coating may be increased such that the coating and the substrate do not have essentially the same ionic charge. Bleed through is avoided in the present invention either because the diameters of the microspheres forming the microcells are greater than the diameter of the holes in the substrate, or because viscosity modifiers have been added or air has been introduced to increase viscosity.

The structural materials of the present invention may be used as standalone products, for example, as a fire resistant foam material, or they may also be used in conjunction with (e.g. as a liner for) a decorative fabric which may itself be fire resistant. The present invention also relates to an article of manufacture comprising the inventive structural materials and/or the inventive fire resistant fabric materials and includes, inter alia, mattress fabrics, mattress covers, mattresses, upholstered articles, building materials, bedroom articles, (including children's bedroom articles), draperies, carpets, tents, awnings, fire shelters, sleeping bags, ironing board covers, barbecue grill covers, fire resistant gloves, airplane seats, engine liners, and fire-resistant clothing for race car drivers, fire fighters, jet fighter pilots, and the like. The use of the fire resistant materials and fire resistant fabric materials of the present invention for manufacturing fabrics for use in articles such as mattresses, cribs, draperies and upholstered furniture, may enable the article to exceed current flammability standards for these types of articles.

### BRIEF DESCRIPTION OF THE FIGURES

The present invention may be better understood with reference to the attached figures in which—

FIG. 1 is a photograph showing the microcells of an exemplary embodiment of a fire resistant fabric material made in accordance with the present invention;

FIG. 2 is a photograph showing the microcells of another exemplary embodiment of a fire resistant fabric material made in accordance with the present invention; and

FIG. 3 is an illustration of an exemplary embodiment of a mattress made in accordance with the invention.

### DETAILED DESCRIPTION

In accordance with the invention, a structural material comprising a prefabricated microcell component, a surfactant component, a surfactant-generated microcell component, a filler component and a binder component is made. As used herein, a prefabricated microcell component is essentially a hollow sphere or a component capable of forming a hollow sphere that has been constructed or manufactured before being employed in the present invention. The prefabricated microspheres are generally made from plastic, polymer, ceramic or glass, acrylic and styrene. The microcells may impart various characteristics to the fire resistant materials of the present invention, including, inter alia, improved fire resistance, flexibility, pliability, drapability, and “bounce back”.

In accordance with the invention, a fabric material is made by covering a substrate with a coating comprising the aforementioned structural material. In a preferred embodiment, the coating does not bleed through the substrate during the fabric making process. In its simplest embodiment, the structural material of the present invention consists essentially of a prefabricated microcells component, a filler component and a binder component.

The filler material of the present invention preferably includes clay. The clay is preferably China clay which is very soft and light. Alternatively, the clay may be Paragon™, which is also a soft clay (i.e. it is soft to the touch), Suprex™, which is a hard clay (i.e. it is hard to the touch), Suprex™ amino silane treated clay, which is used for crosslinking because it will chemically bond with binder, and for highloading, Ballclay™, which has elastic properties (i.e. it feels rubbery), Texwhite 185 (available from Huber, Dry Branch, Ga.), and ECC 1201 (available from Huber). All of above-listed clay products, unless otherwise noted, are available, for example, from Kentucky-Tenn. Clay Company of Langley, S.C. In one embodiment, the clay is Ballclay™ 3380 which is particularly inexpensive compared to other clays. In a preferred embodiment, the clay is Kaolin clay which is a lower grade China clay. In particularly preferred embodiments, the clay is Texwhite 185 or ECC 1201 ( ).

In the present invention, clay is a preferred filler because of its elongation properties (it has a low modulus), its abrasion resistance, its tear resistance, and its tensile strength. Moreover, clay is a good heat barrier; it does not disintegrate when an open flame (temperature ≧1500° F.) is applied directly to a coating of the present invention that includes clay, In addition, clay provides a slick, elastic, glassy surface which exhibits flexibility. Furthermore, as noted, clay is inexpensive and thus can help to keep the cost of the fabric material low.

In another preferred embodiment, the filler is a flame retardant. In a particularly preferred embodiment, the flame retardant is FRD-004.

The filler material may alternatively or additionally comprise a filler selected from the group consisting of decabromodiphenyloxide, antimony trioxide, calcium carbonate, charged calcium carbonate, titanium dioxide, fly ash (such as Alsil O4TR™ class F fly ash produced by JTM Industries, Inc. of Martin Lake and Jewett, Tex. which has a particle size such that less than 0.03% remains on an agitated 0.1 incha×0.1 inch screen), and 3-X mineralite mica (available from Engelhard, Inc. of Louisville, Ky.), or any mixture of these filler materials to meet desired cost and weight criteria. Calcium carbonate may be obtained from Franklin Industrial Minerals of 612 Tenth Avenue North, Nashville, Tenn. 37203.

Calcium carbonate, talc and fly ash filler increase the weight of the product, but utilization of prefabricated microspheres, such as glass and ceramic microspheres, enables the manufacture of a product with reduced weight and increased fire resistant properties. Clay may impart to the product the following nonlimiting characteristics: (1) lower heat build-up, (2) heat reflectance properties, (3) fire barrier properties, (4) no weight loss when exposed to heat and open flame, and (5) reduced disintegration when exposed to heat and open flame. Decabromodiphenyloxide and antimony trioxide impart the following nonlimiting characteristics: (1) flame retardant properties, (2) capability of forming a char, and (3) capability of stopping the spread of flames. It is believed that the gas produced from the heating of the decabromodiphenyloxide can also act as a flame retardant because the gas uses up oxygen or depletes oxygen in the layer next to the fabric and suppresses or stops the fire from further progression.

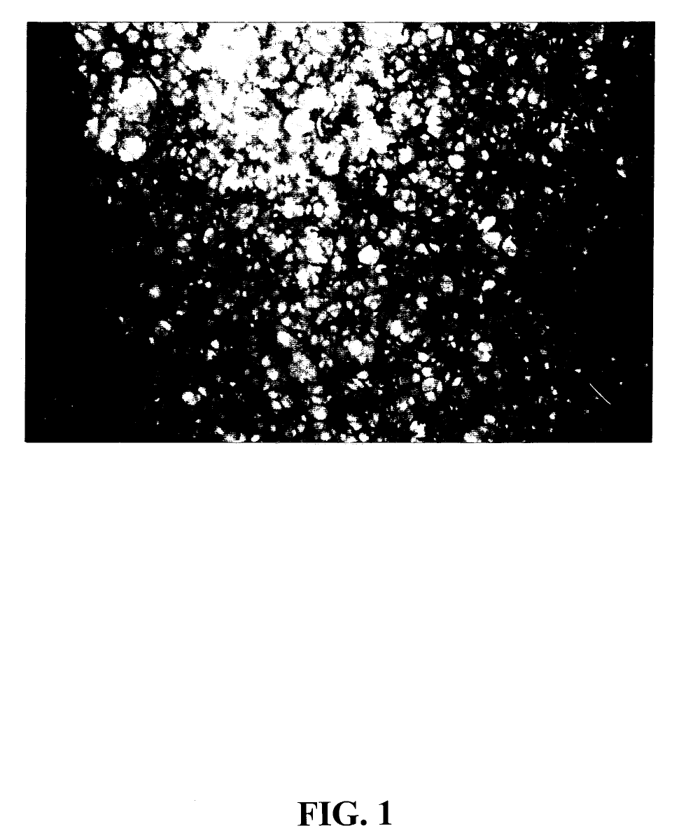

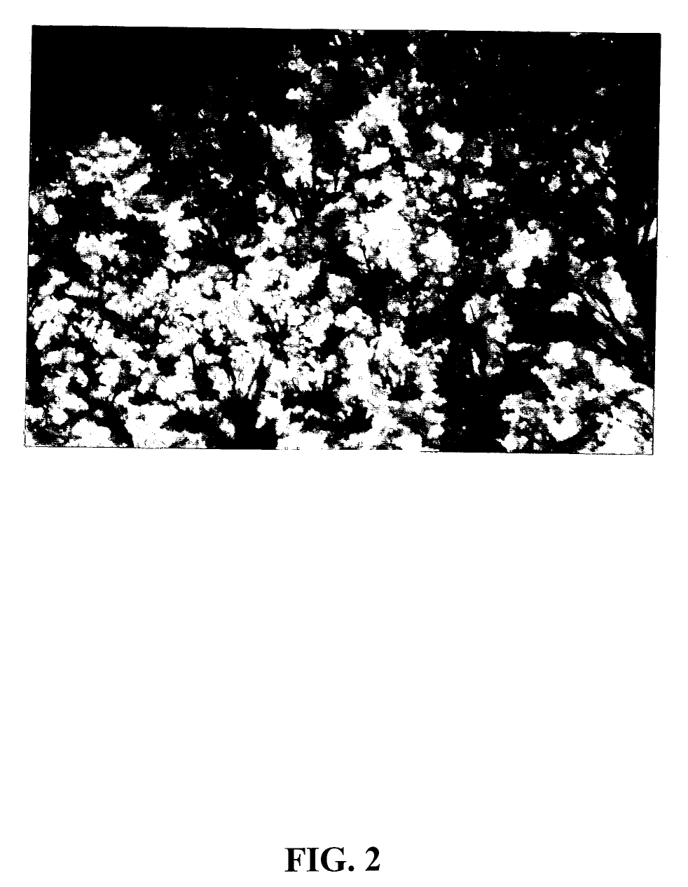

The prefabricated microcell component of the present invention is a component that is a hollow sphere or is capable of forming a hollow sphere and which has been constructed or manufactured before being employed in the present invention. Nonlimiting examples of the prefabricated microcells of the present invention include G-3500 hollow microspheres available from Zeelan Industries (St. Paul, Minn.), Expancel W. Va., Expancel DV, Expancel MB, Expancel WE and Expancel Del. (polymer shells, all available from AKZO NOBEL, Duluth, Ga.), glass microspheres (K1, K15, S15, S22, K20, K25, S32, S60 AND K46, available from Zeelan Industries), ceramic microspheres (G3500, G3400, W 1000, Wl012, W1300 and W1600; available from Zeelan Industries), and Zeeospheres (G200, G850, W410 and W160; available from Zeelan Industries). In one embodiment of the invention, the prefabricated microcells are G3500 ceramic microspheres. FIG. 1 and FIG. 2 show prefabricated microcells of two exemplary embodiments of the invention. Glass microspheres are 2.5 times lighter than ceramic microspheres. Glass and ceramic microspheres can withstand heat greater than 2000° F. Also, glass and ceramic microspheres increase compressive strength, absorb no latex and/or water and thus permit the faster drying of the product. Glass and ceramic microspheres may also increase product flexibility.

The prefabricated microcells of the present invention may help to increase the pot life of the coating. Heavier particles in the fillers, although they may comprise but a small percentage of the particles in the filler, have a tendency to settle near the bottom of a storage vessel. When prefabricated microcells are mixed together with another filler, a dispersion is produced which has an increased pot life or shelf life. Without wishing to be bound by any particular theory, it is believed that as the filler particles naturally fall in the vessel and the prefabricated microcells rise, the smaller size filler particles are supported by the prefabricated microcells, thus enabling the microcells to stay in solution and preventing the filler particles, to at least some extent, from descending to the bottom of the vessel.

The structural material of the present invention is prepared by using a binder component such as a high performance heat-reactive acrylic latex polymer and/or a non-heat reactive styrene butadiene latex to bond the filler materials together. Where the structural material is used to coat a substrate, the binder component also acts to bond the filler to the substrate. Nonlimiting examples of the binder component include Rhoplex 3349 (available from Rohm and Haas, Philadelphia, Pa.), Rovene 4402 (Mallard Creek Polymers, Inc., Akron, Ohio), Hycar™ 26469, Hycar™ 26472, Hycar™ 26484, Hycar™ 26497, Hycar™ 264552, Hycar™ 264512, Hycar™ 264582, Hycar™ 26083 (low formaldehyde), Hycar™ 9201 (low formaldehyde), Hycar9™ 1552 (nitrite), Hycar™ 1571 (nitrite), Vycar™ 552, Hycar™ 2679 acrylic latex polymer (all Hycar™ and Vycar™ products are supplied by B. F. Goodrich Company of Cleveland, Ohio). Binder components may also include Cymel™ 373 (available from American Cyanamid), RHOPLEX™ TR 407 and R&H GL-618 latex both available from Rohm & Haas, and Borden FG-413F UF resin (available from Borden). It is believed, however, that any linear polymer, linear copolymer or branched polymer may be useful in preparing the coating, such as those available from BASF and Goodyear. Further possible binder materials include butyl rubber latex, SBR latex, neoprene latex, polyvinyl alcohol emulsion, SBS latex, water based polyurethane emulsions and elastomers, vinyl chloride copolymers, nitrile rubbers and polyvinyl acetate copolymers. In a preferred embodiment, an SBR latex is used. SBR latex adds good softness characteristics but is not a flame retardant. To improve fire resistance, an acrylic latex may be added or substituted. The more acrylic latex, the better the fire resistance of the material. However, softness is decreased as the SBR latex is substituted. In a preferred embodiment, the binder is Hycar 2679.

In a preferred embodiment, the surfactant component capable of forming microcells during the material making process comprises a fast soap, such as ammonium lauryl sulfate (ALS), (e.g. Stepanol AM; Stepan Chemicals, Northfield, Ill.) and sodium lauryl sulfate (SLS). However, other surfactants may also be used which are not characterized as fast soaps but which are capable of forming microcells. Generally, a “fast soap” is a soap which is capable of efficiently modifying the surface tension of a solvent, such as water. However, other surfactants may also be used which are not characterized as fast soaps but which are capable of forming microcells. Fast soaps, such as ALS, form microcells that are resilient and are generally stable to the heat of processing. Additional components may be added to further stabilize the microcells, as further discussed below. However, if so desired, a surfactant which forms “weak” microcells may be used. The “weak” microcells may burst during processing to produce a less flexible fire resistant material.

When a surfactant is used to introduce surfactant-generated microcells, the structural material may be made by combining the binder component, the prefabricated microcell component, a surfactant component and the filler component together and creating surfactant-generated microcells by any means known in the art, such as, but not limited to, blowing air into the mixture, agitation or by a foamer. In addition, chemical blowing agents, such as azo compounds which release nitrogen gas, may be used to introduce surfactant-generated microcells.

in one embodiment of the invention, the mixture is subjected to a roamer. The roamer acts to inject air into the mixture so that the surfactant forms surfactant-generated microcells within the mixture. The roamer may comprise a tube-like component having a multitude of pins which are capable of rotating in opposing directions (e.g. some pins move clockwise and some move counterclockwise). The mixture of binder, surfactant and filler is added to the roamer through a port on one side and, as it passes through the foamer, the pins rotate causing the surfactant to form microcells. Additional air may also be introduced into the foamer at another port. After having been subjected to the roamer, the mixture may then be applied onto a substrate, such as a fiberglass mat. Alternatively, the mixture may be applied onto a receiving platform, such as a steel tray. Whether applied to a substrate or a receiving platform, the material is then subjected to heat in an oven. Processing temperatures are preferably between about 280° F. and about 350° F. The prefabricated and surfactant-generated microcells are stable to the heat of processing. Generally, surfactant-generated microcells are not stable at temperatures above 350° F.

In one embodiment of the present invention, the heat of processing is necessary for a hollow sphere microcell to form from a prefabricated microcell. In such an embodiment, the prefabricated microcell is in a collapsed state prior to heating and upon heating expands to form the hollow sphere microcell. Examples of prefabricated microcells which require heat to form a hollow sphere include the Expancel microcells listed above.

In another embodiment, the fire resistant material also includes a surfactant capable of regulating surfactant-generated microcell formation. One such surfactant is Stanfex 320 (Parachem, Dalton, Ga.). The surfactant capable of regulating microcell formation can ensure that the microcells remain within a preferred size range (e.g. do not get too big) and form in a relatively monodisperse state (i.e., are of the same general size). In a preferred embodiment, the microcells are about 5.0μ to about 20.0μ. in diameter. In addition, citric acid may be used to ensure that the microcells are spread out uniformly.

It may also be desirable for the fire resistant materials to include a dispersant which acts to keep the mixture comprising the binder, surfactant and filler well dispersed during the material making process. Examples of such dispersants include, inter alia, TSPP, Accum 9300, Accum 9400 and Accum 9000 (all available from Rohm & Haas).

The fire resistant fabric materials of the present invention are flexible, pliable and have good drapability characteristics. In addition they are durable and preferably do not crack upon bending. Durability of the fire resistant material may be enhanced by adding components capable of stabilizing the surfactant-generated microcells. Such components include surfactants such as ammonium stearate, octosol A18 (Tiarco Chemicals, Dalton, Ga.), A-1 (disodium n-alkylsulfosuccinate; Tiarco Chemicals), 449 (Parachem), and Stanfex 320. The microcell may be stabilized by making the wall of the microcell thicker. A surfactant which comprises a long waxy chain may be particularly useful for stabilizing the surfactant-generated microcells.

The structural material may further include a cross-linking component, such as melamine (Borden Chemicals, Morganton, N.C.), and/or ammonium chloride. The cross-linking component is useful to improve durability and reduce cracking. In order to control the amount and rate of cross-linking, it may be desired to control the pH of the mixed components. For example, in acidic conditions (pH ˜4.0), the cross-linking will occur very quickly and the mixture will have a short pot-life. At higher pH (˜10.0), the cross-linking proceeds more slowly and can be controlled by heat.

The structural material of the present invention may also comprise resin which may provide a polymer shell to encapsulate air. In one embodiment, the resin is DPG-38, available from Parachem of Dalton, Ga.

In a preferred embodiment, the fire resistant material further possesses “bounceback” characteristics. As used herein, “bounceback” refers to the ability of the material to return to its original shape after having been distorted, such as stretched or compressed. In such an embodiment, additional components are added to achieve such bounceback characteristics. These components may coat the inside of the surfactant-generated microcell such that the microcell reverts to its original shape after having been distorted. Preferred components useful for achieving bounceback characteristics include CTO101(silicon oil, Kelmar Industries, Duncan, S.C.), Freepel 1225 (BF Goodrich, Cleveland, Ohio), Sequapel 409 (Omnovasolutions, Chester, S.C.), Michem emulsion 41740 (Michelman Inc., Cincinnati, Ohio), Syloff-1171A (Dow Corning Corp., Midland, Mich.), Syloff-62 (Dow Corning), Syloff-7910 (Dow Corning) and Aurapel 391 (Sybron/Tanatex, Norwich Conn.). These components also ensure that the microcells do not aggregate and form clumps of microcells.

The substrate of the present invention may be any suitable reinforcement material capable of withstanding processing temperatures, such as glass fibers, polyester fibers, cellulosic fibers, asbestos, steel fibers, alumina fibers, ceramic fibers, nylon fibers, graphite fibers, wool fibers, boron fibers, carbon fibers, jute fibers, polyolefin fibers, polystyrene fibers, acrylic fibers, phenolformaldehyde resin fibers, aromatic and aliphatic polyamide fibers, polyacrylamide fibers, polyacrylimide fibers or mixtures thereof which may include bicomponent fibers. The substrate provides strength for the fire resistant fabric material.

Examples of substrates in accordance with the invention include, inter alia, glass, fiberglass, ceramics, graphite (carbon), PBI (polybenzimidazole), PTFE, polyaramides, such as KEVLAR™ and NOMEX™, metals including metal wire or mesh, polyolefins such as TYVEK™, polyesters such as DACRON™ or REEMAY™, polyamides, polyimides, thermoplastics such as KYNAR™ and TEFZEL™, polyether sulfones, polyether imide, polyether ketones, novoloid phenolic fibers such as KYNOL™, KoSa™ polyester fibers, JM-137 M glass fibers, Owens-Coming M glass, Owens-Coming K glass fibers, Owens-Coming H glass fibers, Evanite 413M glass microfibers, Evanite 719 glass microfibers, cellulosic fibers, cotton, asbestos and other natural as well as synthetic fibers. The substrate may comprise a yarn, filament, monofilament or other fibrous material either as such or assembled as a textile, or any woven, non-woven, knitted, matted, felted, etc. material. The polyolefin may be polyvinyl alcohol, polypropylene, polyethylene, polyvinyl chloride, polyurethane, etc. alone or in combination with one another. The acrylics may be DYNEL, ACRILAN and/or ORLON. RHOPLEX AC-22 and RHOPLEX AC-507 are acrylic resins sold by Rohm and Haas which also may be used. The cellulosic fibers may be natural cellulose such as wood pulp, newsprint, Kraft pulp and cotton and/or chemically processed cellulose such as rayon and/or lyocell.

Nonlimiting examples of non-woven materials that may be useful in the present invention include non-woven, continuous fiberglass veils, such as Firmat™ 100, Pearlveil™ 110, Pearlveil™ 210, Curveil™ 120, Curveil™ 220, Flexiveil™ 130, Flexiveil™ 230 and Pultrudable veil (all available from Schmelzer Industries, Inc., Somerset, Ohio). The woven materials may be Airlaid™, Spunbond™ and Needlepunch™ (available from BFG Industries, Inc. of Greensboro, N.C.). Nonlimiting examples of filament materials include D, E, B, C, DE, G, H, K filaments of various grades, including electrical grade, chemical grade and high strength grade (all available from BFG Industries, Inc. of Greensboro, N.C.).

In a preferred embodiment, the substrate is a woven fiberglass mat. As used herein, a fiberglass mat includes nonwoven and woven fiberglass mats. In a particularly preferred embodiment, the substrate of the present invention is a woven fiberglass mat such as style 1625, style 1091 and style 1614 of BGF Industries (Greensboro, N.C.).

The use of the structural materials of the present invention for manufacturing fabrics for use in articles such as mattresses, cribs, drapes and upholstered furniture, may enable the article to exceed current flammability standards for these types of articles. While flammability standards for mattresses have not specifically been set by the federal or state governments, some government agencies have provided recommended guidelines.

For example, the United States Department of Commerce National Institute of Standards and Technology (NIST) in Gaithersburg, Md. has published a paper relating to a methodology for assessing the flammability of mattresses. See T.J. Ohlemiller et al., Flammability Assessment Methodology for Mattresses, NISTIR 6497, June 2000. While no clear standard is given, it is recommended that a mattress be able to withstand the described test procedures. The NIST has noted that beds pose a unique fire hazard problem. It provides a series of tests for determining the flammability of mattresses.

In addition, the State of California Department of Consumer Affairs Bureau of Home Furnishings and Thermal Insulation (“the Bureau”) issued a Technical Bulletin in October 1992 which provides a flammability test procedure for mattresses. See State of California Department of Consumer Affairs Bureau of Home Furnishings and Thermal Insulation Technical Bulletin 129, October 1992, Flammability Test Procedurefor Mattresses for use in Public Buildings (California TB129). The technical bulletin provides standard methods for fire testing of mattresses. The methods produce data describing the burning behavior from ignition of a mattress until all burning has ceased, or after a period of one hour has elapsed. The rate of heat release is measured by an oxygen consumption technique. The Bureau indicates that mattresses complying with the test method will be safer and hopes that manufacturers will attempt to manufacture mattresses which pass the recommended tests. The Bureau indicates that “a mattress fails to meet the requirements of the test if any of the following criteria are exceeded:” (1) a maximum rate of heat release of 100 kW or greater, (2) a total heat release of 25 MJ or greater in the first 10 minutes, and (3) weight loss of 3 pounds or greater within the first 10 minutes due to combustion. A mattress manufactured with the fire resistant fabric material of the present invention complies with or exceeds the test standards recommended by both the NIST and the California TB 129.

As indicated, the fire resistant fabric material of the present invention is useful in the manufacture of mattresses. In this embodiment of the invention, the fire resistant fabric material may be used to line a decorative mattress fabric to produce a fire resistant mattress fabric. Nonlimiting examples of mattress fabrics include ticking (known in the art as a strong, tightly woven fabric comprising cotton or linen and used especially to make mattresses and pillow coverings), or fabrics comprising fibers selected from the group consisting of cotton, polyester, rayon, polypropylene, and combinations thereof. The lining may be achieved by methods known in the art. For example, the fire resistant fabric material of the present invention may simply be placed under a mattress fabric. Or, the fire resistant mattress material may be bonded or adhered to the mattress fabric, for example using a flexible and preferably nonflammable glue or stitched with fire resistant thread i.e., similar to a lining. The fire resistant mattress fabric of the present invention may then be used by the skilled artisan to manufacture a mattress which has improved flammability characteristics.

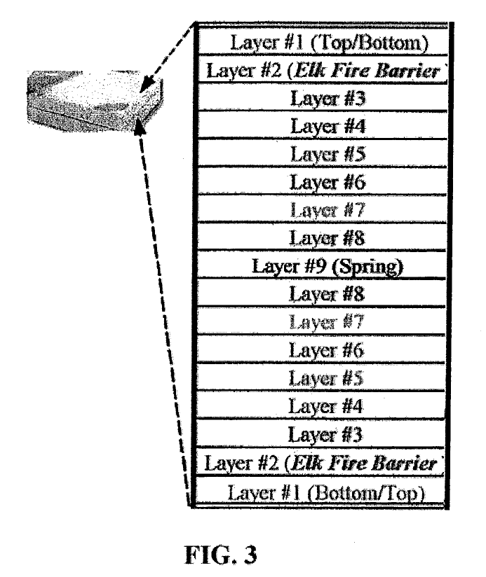

The mattresses of the present invention which comprise the fire resistant fabric material may be comprised of several layers, including, but not limited to at least one first layer which comprises a fabric layer (such as the mattress fabrics discussed above), at least one layer which comprises the fire resistant fabric material of the present invention (which may, for example be a second layer or a third layer), at least one cushion layer, at least one polyurethane foam layer, at least one non-woven sheeting layer and a layer comprising springs. The layer comprising the fire resistant fabric material of the present invention, as indicated above, comprises a substrate and a coating. In one embodiment, the fire resistant fabric material is coated on one side and the side with the coating is facing the first layer. However, as indicated above, the fire resistant fabric material may be coated on both sides. 1000481 In a particular embodiment of the invention, the mattress comprises at least one first layer comprising a mattress fabric and at least one second layer adjacent to the first layer and comprising the fire resistant fabric material of the present invention. The fabric of the first layer may be the mattress fabric discussed above, such as ticking, or a fabric comprising fibers selected from the group consisting essentially of cotton, polyester, rayon, polypropylene, and combinations thereof 1000491 The non-woven sheeting layer may be any suitable material known in the art. For example, the non-woven sheet layer may be made from any noncombustible fibers. In a preferred embodiment, the non-woven sheet layer is made from fiberglass fibers. The mattress of the present invention may further comprise at least one third layer adjacent to the second layer and at least one fourth layer adjacent to the third layer wherein each of the third and fourth layer is a cushion layer and at least one fifth. layer adjacent to the fourth layer and which comprises polyurethane foam. The cushion layer may be made of polyester fibers or any fibers known in the art to be suitable for making a layer which provides cushioning. The polyurethane foam may be of varying thickness. Furthermore, the mattress of the present invention may comprise at least one sixth layer adjacent to the fifth layer and comprising the fire resistant fabric material. FIG. 3 shows an exemplary mattress in accordance with the present invention.

In one embodiment of the invention, the polyurethane foam may be the second layer of the mattress (i.e. under the ticking and in place of polyester fiber). The polyurethane foam layer provides a superior cushioning effect. However, the total weight of the polyester foam layer together with the ticking must be less than 3 lbs because the polyester foam and the ticking burn and the mattress will not pass the burn tests if more than 3 lbs is lost. In such an embodiment, a preferred thickness for the foam is approximately 0.25 inches.

The mattress of the present invention may further comprise a fire resistant border. In one embodiment, the border of the present invention comprises a first layer comprising a mattress fabric; and a second layer adjacent to the first layer and comprising the fire resistant fabric material of the present invention. In addition, the border may comprise a third layer adjacent to the second layer and which comprises a polyurethane foam. The border may also comprise fourth layer, adjacent to the third layer, and which comprises a non-woven sheet. Alternatively, the border may comprise a fourth layer, adjacent to the third layer, and which comprises the fire resistant fabric material of the present invention and a fifth layer, adjacent to the fourth layer, and which comprises a non-woven sheet.

In another embodiment of the present invention, the mattress comprises at least one first layer comprising a mattress fabric, at least one second layer, adjacent to the first layer, and which comprises the fire resistant fabric material of the present invention, at least one third layer adjacent to the second layer, and which comprises polyurethane foam, at least one fourth layer adjacent to the third layer, and which comprises a non woven sheet, at least one fifth layer adjacent to the fourth layer and which comprises a fibrous pad and at least one sixth layer adjacent to the fifth layer and which comprises another fibrous pad which may be the same as or different from the fifth layer. All of the aforementioned embodiments of the mattress of the present invention passed all fire tests.

In a preferred embodiment, the mattress of the present invention comprises at least one first layer which comprises a mattress fabric, at least one second layer adjacent to the first layer wherein the second layer is a cushion layer, and at least one third layer adjacent to the second layer, and which comprises the fire resistant fabric material of the present invention. The mattress may further comprise at least one fourth layer adjacent to the third layer and wherein the fourth layer is a cushion layer, at least one fifth layer, adjacent to the fourth layer, and which comprises polyurethane foam, and at least one sixth layer, adjacent to the fifth layer, and which comprises a non-woven sheet. The cushion layer may be made from any fiber known in the art suitable for making a cushion. In a preferred embodiment, the cushion layer comprises polyester fibers. In a particularly preferred embodiment, from a comfort standpoint, but not a fire resistance standpoint the second layer is a two ounce polyester fiber layer.

As indicated above for certain embodiments of the mattresses of the present invention, the coating of the fire resistant fabric material faces the first layer. As used herein, “faces the first layer” means that the fire resistant fabric material has a coating on one or both sides. If the coating is on one side, that side faces the first layer, with the uncoated side facing away from the first layer. In addition, the numbers of the layers indicates the order of the layers. For example, if the mattress fabric is the first layer, this layer is the top of the mattress, with the second layer being adjacent to the first layer, the third layer is adjacent to the second layer, and so on.

In addition to the layers described above, the mattresses of the present invention may comprise other layers which may comprise one or more fibrous pad layers and/or a spring layer. The mattresses may also comprise a border, such as the border described above. Further materials which may be incorporated into the mattress of the present invention include construction materials, such as non fire retardant or fire retardant thread for stitching the mattress materials together (e.g. glass thread or Kevlar thread) and non-fire retardant or fire retardant tape. Silicon may be used with Kevlar thread to diminish breakage and enhance production time. In a particularly preferred embodiment of the present invention, conventional tape and/or conventional thread may be used and the mattress still complies with the California TB 129 test requirements.

The fire resistant materials of the present invention may be used to produce materials with similar characteristics to foam and cushion layers used in mattresses and may replace or be added in addition to such layers. In such an embodiment, the foam and cushioning layers made with the fire resistant materials of the present invention impart fire resistance to the mattress when used therein.

Table I below provides, in approximate percentages, the components of the coating the applicants have used in a preferred embodiment of structural material of the invention.

TABLE I

| | |
|---|---|
| Coating Components | % Wet |

BINDER

| | |
|---|---|
| Hycar 2679 | 25.00 |

FILLER

| | |
|---|---|
| FRD-004 | 27.26 |

PREFABRICATED MICROCELLS

| | |
|---|---|
| G-3500 | 18.00 |

CROSS-LINKER

| | |
|---|---|
| Melamine | 5.00 |

MISCELLANEOUS

| | |
|---|---|
| Water | 25.74 |
| Total Percentage | 100.00% |

SUBSTRATE = BGF Industries Style 1625 fiberglass mat.

Although the table shows possible combinations of binder, filler and prefabricated microcells, it is believed that other combinations may be employed.

The fire resistant fabric materials, as mentioned, include a substrate and a coating which comprises the structural material of the present invention. The coating (structural material) comprises approximately 34% by weight of the fire resistant fabric material. In the coating, about 10% to about 55% by weight is binder, about 2% to about 45% is prefabricated microcells, and from about 2% to about 45% is filler. In a preferred embodiment, the coating comprises about 25% binder, about 18% prefabricated microcells and about 18% filler (clay) and the remainder is water. The substrate is preferably woven glass. The substrate may also be, for example, a woven fabric of DE, E, H, or G filament available from BFG Industries. The substrate is approximately 66% by weight of the fire resistant fabric material. The binder which bonds together the glass fibers is approximately about 25% to about 55% B. F. Goodrich 2679 Acrylic Latex. Any suitable binder may be used, including those listed herein above.

In the inventive fire resistant fabric materials, the substrate may be coated by air spraying, dip coating, knife coating, roll coating or film application such as lamination/heat pressing. The coating may be bonded to the substrate by chemical bonding, mechanical bonding and/or thermal bonding. Mechanical bonding is achieved by force feeding the coating onto the substrate with a knife.

Structural materials and fire resistant fabric materials made in accordance with this invention may be of any shape. Preferably, such articles are planar in shape. The structural materials may be used in any of a variety of products, including, but not limited to mattress/crib fabrics, mattress/crib covers, upholstered articles, bedroom articles, (including children's bedroom articles), draperies, carpets, wall coverings (including wallpaper) tents, awnings, fire shelters, sleeping bags, ironing board covers, fire resistant gloves, furniture, airplane seats and carpets, fire-resistant clothing for race car drivers, fire fighters, jet fighter pilots, and the like, building materials, such as roofing shingles, structural laminate facing sheets, building air duct liners, roofing underlayment (or roofing felt), underlayment for organic, built up roofing materials, roll roofing, modified roll products, filter media (including automotive filters), automotive hood liners, head liners, fire walls, vapor barriers etc.

The structural material may be used alone or may be used as a liner for a decorative fabric, such as the type used for mattresses, drapes, sleeping bags, tents etc. which may also be fire resistant.

The substrate may be coated on one side or both sides depending on the intended application. For instance, if one side of the substrate is coated with the filler/binder coating, the other surface can be coated with another material. In the roofing materials industry, for example, the other material may be conventional roofing asphalt, modified asphalts and non-asphaltic coatings, and the article can then be topped with roofing granules. It is believed that such roofing material could be lighter in weight, offer better fire resistance and better performance characteristics (such as cold weather flexibility, dimensional stability and strength) than prior art roofing materials.

The mixture comprising the binder component, the prefabricated microcell component and the filler component may have a consistency of a light foam, such as shaving cream. It is believed that due to the low density of the mixture, the microcells do not pass through the substrate when applied thereto. If desired, however, the viscosity of the coating can be increased through mixing to ensure that it does not bleed through the substrate. Nonlimiting examples of thickening agents include Acrysol ASE-95NP, Acrysol ASE-60, Acrysol ASE-1000, Rhoplex ASE-75, Rhoplex ASE-108NP, and Rhoplex E-1961, all available from Rohm & Haas.

Additionally, the fire resistant material may be coated with a water repellent material or the water repellent material may be added in the coating (i.e., internal water proofing). Two such water repellent materials are Aurapel™ 330R and Aurapel™ 391 available from Sybron/Tanatex of Norwich, Conn. In addition, Omnova Sequapel™ and Sequapel 417 (available from Omnovasolutions, Inc. of Chester, S.C.); BS-1306, BS-15 and BS-29A (available from Wacker of Adrian, Mich.); Syl-off™-7922, Syl-off™-1171 A, Syl-off™—7910 and Dow Corning 346 Emulsion (available from Dow Corning, Corporation of Midland, Mich.); Freepel™-1225 (available from BFG Industries of Charlotte, N.C.); and Michem™ Emulsion-41740 and Michem™ Emulsion-03230 (available from Michelman, Inc. of Cincinnati, Ohio) may also be used. It is believed that wax emulsions, oil emulsions, silicone emulsions, polyolefin emulsions and sulfonyls as well as other similar performing products may also be suitable water repellent materials. As indicated above, these materials are also useful for imparting bounceback characteristics to the fire resistant materials of the present invention. Water repellents may be particularly preferred for example, in the manufacture of crib mattresses, for airplane seats and in the manufacture of furniture, particularly for industrial use.

A defoamer may also be added to the coating of the present invention to reduce and/or eliminate foaming during production. One such defoamer is Y-250 available from Drews Industrial Division of Boonton, N.J.

Fire retardant materials may also be added to the fire resistant materials of the present invention to further improve the fire resistance characteristics. Nonlimiting examples of fire retardant materials which may be used in accordance with the present invention include FRD-004 (decabromodiphenyloxide; Tiarco Chemicals, Dalton, Ga.), FRD-01, FR-10, FR-11, FR-12, FR-13, FR-14 (all available from Tiarco Chemicals) zinc oxide, and ATH.

In addition, color pigments, including, but not limited to, T-113 (Abco, Inc.), W-4123 Blue Pigment, W2090 Orange Pigment, W7717 Black Pigment and W6013 Green Pigment, iron oxide red pigments (available from Engelhard of Louisville, Ky.) may also be added to the coating of the present invention to impart desired characteristics, such as a desired color.

The additional coatings of, e.g. water repellent material, antifungal material, antibacterial material, etc., may be applied to one or both sides of fire resistant materials and fire resistant fabric materials. For example, fire resistant fabric materials comprising substrates coated on one or both sides with filler/binder coatings could be coated on one side with a water repellent composition and on the other side with an antibacterial agent. Alternatively, the water repellent material, antifungal material, antibacterial material, etc., may be added to the coating before it is used to coat the substrate.

### EXAMPLE

### Example 1

### Fire Resistant Fabric Material

To produce the structural materials of the present invention, the applicant formulated the coating using just four major components, water, filler, prefabricated microcells and binder (see Table I above). The amounts of the major constituents were as follows: approximately 25% Hycar 2679 binder, 27.26% FRD-004 clay filler, and 18% G-3500 prefabricated microcells. In addition, 5% matroel NW3A (melamine) crosslinker was added. The components were mixed in a reaction or mixing kettle for 45 minutes at a temperature of 65˜95° F.

The mixture was used to coat a fiberglass mat on one and both sides. The mat was manufactured by BFG Industries, Inc. of Greensboro, N.C. and was style number 1625 and had a basis weight in the range of 1.80 lb./sq. to 1.90 lb./sq. The mat had a porosity in the range of 600 to 650 cfM/ft². The coated article was durable and flexible and did not crack on bending and possessed “bounceback” characteristics. Typical tensile strength measurements for uncoated versus coated were 47 lbs/3″ and 171 lbs/3″ respectively. Typical Elmendorff tear strength measurements were ≧3400 grams without the sample tearing.

The fire resistant fabric material was checked for combustibility. When exposed to the flame of a Bunsen burner from a distance of two inches, woven fabric and wet lay fabric failed the fire test (i.e. the glass fiber melted or a hole was created where the flame hit the fabric). However, when the fire resistant fabric material of the present invention was exposed to the flame of a Bunsen burner from a distance of two inches for a period of five minutes or more, no hole was created and the glass fibers did not melt. The coating protected the glass fabric from melting or disintegrating and the integrity of the glass fabric structure was maintained. In addition, when cotton was laid on top of the fire resistant fabric material such that the fire resistant fabric material is between the Bunsen burner and the cotton, the cotton also was protected from the flame of the Bunsen burner.

The Technical Bulletin 129 of the State of California Department of Consumer Affairs Bureau of Home Furnishings and Thermal Insulation (October 1992) indicates that a fabric should maintain integrity when exposed to an open flame for 20 minutes and that test was passed in the lab with the fire resistant fabric material of the present invention.

The invention provides a fire resistant fabric material which is flexible, pliable, and has good drapability characteristics and which shows no signs of cracking, etc. The fire resistant fabric material has a porosity of less than 18 cfm (uncoated has a porosity of 440 cfm) and may adhere very well to other materials, including decorative fabrics, polyurethane foam, isocyanurate foam, asphaltic compounds, and granules (non-asphaltic shingle components).

The fire resistant fabric material may have few pinholes or may have numerous pinholes and still maintain a porosity of less than from approximately 17 to approximately 19 cfm when coated with solvent based adhesive such as Firestone Bonding Adhesive BA-2004 which does not bleed through the coated product.

The application of the coating to the substrate was accomplished by knife coating. In addition, the coating may also be performed by, frothing and knife coating, foaming and knife coating, foaming and knife coating and crushing, dip coating, roll coating (squeezing between two rolls having a gap that determines the thickness of the coating), by a hand-held coater which can be obtained from the Gardner Company, spraying, dipping and flow coating from aqueous or solvent dispersion, calendering, laminating and the like, followed by drying and baking, may be employed to coat the substrate as is well known in the art.

After coating, the samples were placed in an oven at approximately 325° F. for about two minutes to achieve drying and curing. Additionally, the coating may be separately formed as a film of one or more layers for subsequent combination with a substrate.

It should be understood that the above examples are illustrative, and that compositions other than those described above can be used while utilizing the principles underlying the present invention. For example, other sources of filler as well as mixtures of acrylic latex and/or surfactants can be used in formulating the structural materials of the present invention. Moreover, the coating compositions can be applied to various types of substrates, as described above.

What is claimed is:

1. A structural material comprising a prefabricated microcells component, a surfactant component, surfactant-generated microcells, a filler component and a binder component.

2. A fabric material comprising a substrate coated with a structural material comprising a prefabricated microcells component, a surfactant component, surfactant-generated microcells, a filler component and a binder component.

3. The fabric material according to claim 2 wherein said substrate is planar and is coated on one side with said structural material.

4. The fabric material according to claim 2 wherein said substrate is planar and is coated on both sides with said structural material.

5. The fabric material according to claims 2, 3 or 4, wherein said fabric material further includes a water repellent material.

6. The fabric material according to claims 2, 3 or 4, wherein said fabric material further includes an antifungal material.

7. The fabric material according to claims 2, 3 or 4, wherein said fabric material further includes an antibacterial material.

8. The fabric material according to claims 2, 3, or 4, wherein said fabric material further includes a surface friction agent.

9. The fabric material according to claims 2, 3 or 4, wherein said fabric material further includes a flame retardant material.

10. The fabric material according to claims 2, 3, or 4, wherein said fabric material further includes an algaecide.

11. The fabric material according to claims 2, 3 or 4, wherein said fabric material is colored with dye.

12. A mattress fabric comprising a decorative fabric and a fabric material comprising a substrate coated with a structural material comprising a prefabricated microcells component, a filler component and a binder component.

13. A mattress fabric comprising a decorative fabric and a fabric material comprising a substrate coated with a structural material comprising a prefabricated microcells component, a surfactant component, surfactant-generated microcells, a filler component and a binder component.

14. A mattress comprising a decorative fabric and a fabric material comprising a substrate coated with a structural material comprising a prefabricated microcells component, a filler component and a binder component.

15. A mattress comprising a decorative fabric and a fabric material comprising a substrate coated with a structural material comprising a prefabricated microcells component, a surfactant component, surfactant-generated microcells, a filler component and a binder component.

16. A structural material consisting essentially of a prefabricated microcells component, a filler component and a binder component.
